(19) United States
(12) Patent Application Publication
(10) Pub. No.: US 2005/0023156 A1
(43) Pub. Date: Feb. 3, 2005

(54) Nanostructured material transport devices and their fabrication by application of molecular coatings to nanoscale channels

(76) Inventors: J. Michael Ramsey, Knoxville, TN (US); Tony E. Haynes, Knoxville, TN (US); Leonard C. Feldman, Nashville, TN (US); David M. Zehner, Lenoir City, TN (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/629,970

(22) Filed: Jul. 30, 2003

(51) Int. Cl. B05D 5/12; B82B 3/00; B82B 1/00; G01N 27/327

(52) U.S. Cl. 205/792; 205/775; 427/58; 427/523; 427/230; 977/DIG. 1; 428/304.4

(57) ABSTRACT

Nanostructured material transport devices and their method of fabrication, which involves applying molecular coatings to nano-openings in the devices to reduce the lateral dimensions and modify liquid solid interface characteristics of the nano-openings. Material transport devices having nano-openings with lateral dimensions confined to approximately 1 nm are obtainable.

### GOVERNMENT RIGHTS STATEMENT

This invention was made with Government support under contract DE-AC05-00OR22725 awarded by the United States Department of Energy to UT-Battelle, LLC. The Government has certain rights in this invention.

### FIELD OF THE INVENTION

The present invention relates to the field of nanofluidics, involving the active transport of material through nanoscale (<1000 nm) conduits. More particularly, the present invention provides a new approach to the fabrication of nanostructured material transport devices, utilizing molecular coating methods to apply a molecular film of controlled thickness to a nanoopening formed by conventional fabrication techniques in order to further reduce the cross-sectional channel dimensions of the opening. The resulting nanostructured device has orifices or conduits that are nanoscale in at least one dimension.

### BACKGROUND OF THE INVENTION

Interest in microfabricated devices for chemical analysis and synthesis has grown substantially over the past decade, primarily because these “microchips” have the capability to provide information rapidly and reliably at low cost. Microchips fabricated on planar substrates are advantageous for manipulating small sample volumes, rapidly processing materials and integrating sample pretreatment and separation strategies. The ease with which materials can be manipulated and the ability to fabricate structures with interconnecting channels that have essentially no dead volume contribute to the high performance of these devices. In addition, integrated microfluidic systems provide significant automation advantages, as fluidic manipulations are subject to computer control. See, for example, U.S. Pat. Nos. 5,858,195 and 6,001,229 which are commonly owned with this application.

Many different kinds of functional elements can be designed and integrated on microchips to provide miniaturized total analysis or lab-on-a-chip systems. Such elements include filters, valves, pumps, mixers, reactors, separation columns, cytometers and detectors, which can be operatively coupled together under computer control, thereby enabling the implementation of a wide range of microchip-based analyses. Microchips incorporating combinations of these elements are commonly referred to as “lab-on-a-chip” devices.

The successes achieved to date in microfluidics stimulated interest in nanoscale fluidics. There are many interesting and potentially valuable devices that could be obtained by the ability to fabricate nanostructured devices with nano-openings having cross-sectional dimensions approaching molecular dimensions (approximately 1 nm). The ability to fabricate nanostructured devices with cross-sectional dimensions at the molecular scale is expected to allow fundamental studies of fluid transport at the smallest conceivable dimensions. Potential applications of nanofluidics include, without limitation, analysis of biopolymers, such as DNA and proteins, synthetic polymers, simulation of processes in biological systems such as transmembrane receptors, performance of single-molecule chemical reactions and fabrication of nanoscale components by mechanical or molecular assembly. Moreover, it may be possible to form electronic devices such as logic gates, transistors, or memories.

The possibility of single molecule DNA sequencing was recognized as early as 1996, when Kasianowicz, et al., Proc. Natl. Acad. Sci. U.S.A., 93: 13770-13773 (1996) discovered that an electric field can drive single-stranded RNA and DNA molecules through α-hemolysin nanopores with an opening of 2.6 nm and narrowest constriction of ˜1.5 nm. This technique was used to measure polynucleotide length. This and subsequent experiments have raised the possibility of using the translocation of a single-stranded DNA molecule through a nanopore to carry out fast DNA sequencing by measuring the current and translation speed characteristics Meller, et al., Proc. Natl. Acad. Sci. USA 97: 1079 (2000). Akeson, et al., Biophys. J. 77: 3227-3233 (1999). Presently, these techniques can distinguish a short sequence of purines from one of pyrimidine. A major impediment to achieving single nucleotide resolution is background noise due to the thermal motion of the ions in the solvent. Another substantial problem with this technique concerns the fragile nature of the bio-nanopore. Andersen, Biophys. J. 77: 2899 (1999). Deamer and Akeson, Trends in Biotech, 18: 147 (2000).

Existing methods for fabricating submicron channels for material transport rely largely on wet or dry chemical etching procedures. The lateral size of channel features formed by such methods is defined and limited by lithographic patterning. Presently, photolithography is limited to about 100 nm or greater for defining feature size. Channel depths can be controlled by adjusting etching rates and times. In amorphous materials such as glass, which are commonly used substrates for fluidic devices, wet etching methods typically result in maximum channel widths that are equal to the photolithographic mask width plus two times the etch depth. Channel depths, in theory, can be formed that are very shallow (a few atomic layers) but may be limited practically by cover plate bonding. Clearly photolithographic-based fabrication methods limit how small fluidic channels can be made.

A top-down approach that might be effective to form nanochannels is the use of finely focused ion beam milling. These devices employ energetic ion beams focused to a spot of about 10 nm to sputter away a substrate material. The ion beam can “write” a two-dimensional pattern in the substrate with roughly the dimension of the ion beam spot size and thus could be used to form nanochannels. In practice, ion beam milling features are typically limited to length scales of a few tens of nanometers, again considerably larger than the desired size of approximately 1 nm.

There are also other alternative methods for top-down formation of submicron channels. Electron beam lithography can be used to write features approaching the 10-nm scale in appropriate resists Hui, F. Y. C., and G. Eres, “Factors Affecting Resolution in Scanning Electron Beam Induced Patterning of Surface Adsorption Layers”, Appl. Phys. Lett., 72, 341 (1998). Features of similar length scale can then be machined in a substrate using either wet (solution) or dry (plasma) etching techniques. It may also be possible to use proximal probe techniques to perform lithography or to directly etch features in a substrate at the nanometer length scale.

Other efforts toward making the transition from microscale to nanoscale fluidic devices have included random arrays of nanopores in polymeric membranes, Jirage, et al., Nanotubule-based molecular-filtration membranes. Science, 278(5338): 655-658 (1997) or biological nanopores inserted into lipid membranes, Gu, et al., “Stochastic sensing of organic analytes by a pore-forming protein containing adaptor”, Nature 398, 686 (1999). Fabricated nanofluidic structure have been reported recently. Han and Craighead, Science, 288:1026-28(2000). This work involved channels with only one-dimensional nanoscale confinement (30 microns wide by 100 nanometers deep) More recently, a pore of approximately 5-nm diameter has been formed in silicon nitride using ion beam machining. Li, et al., Ion-beam sculpting at nanometer length scales. Nature, 412: p. 166 (2001). This later work forms a nanometer scale hole through a substrate rather than forming a nanometer conduit in the plane of the substrate.

New fabrication techniques must be developed if the full potential of nanofluidics is to be realized.

### SUMMARY OF THE INVENTION

In accordance with one aspect of the present invention, there is provided a method of reducing a cross-sectional dimension of a nano-opening in a nanostructured material transport device. In carrying out the method of the invention, a nano-opening defined by at least one wall surface is fabricated in a solid substrate, the nano-opening having a given first cross-sectional area of nanometer-scale dimensions which is bounded by said at least one wall surface; and a coating material having a defined thickness is applied to said at least one wall surface, thereby causing the nano-opening to have a second cross-sectional area of nanometer-scale dimensions reduced relative to the first cross-sectional area. The “at least one wall surface” referred to above may comprise three or four wall surfaces defining a substantially rectangular open or closed nanochannel, depending on the stage of the method at which the channel is enclosed with a cover member, or it may be a continuous wall defining a hollow cylinder, which has a pore size opening. The cover member may have a coating on its surface which is the same as that applied to the substrate or it may have a surface with a different chemical nature than the substrate, including its native chemical nature.

The nanochannel can be enclosed with the cover member after coating of the nanochannel. Alternatively the cover member can be bonded to the substrate to enclose the open nanochannel having the appropriate dimensions followed by a procedure to coat the closed channel walls. This approach provides reduction of the width and depth of the nanochannel feature by approximately two times the coating thickness. The channel wall coating can be applied by transporting the coating reagent through the closed channel.

The chemical nature of the coating material may be varied so as to modify the liquid-solid interface characteristics of the device, as will be described below.

According to another aspect of the invention a method is provided for producing a nanometer-scale conduit in a nanostructured device, involving the steps of: providing a solid substrate having an uncovered surface in which is formed an open nanochannel having a bottom wall spaced below the uncovered surface and opposed side walls, the nanochannel having a given first cross-sectional channel area of nanometer-scale dimensions defined by the free space between the opposed sidewalls and the depth of the bottom wall below the uncovered surface. A coating material having a defined thickness is applied to the opposed side walls and bottom wall to reduce the free space between the coated opposed side walls by a factor of two times the defined thickness, thereby to reduce the free space in said first cross sectional area to provide a flow channel having a flow area with a second cross-sectional area of lesser nanometer-scale dimensions relative to the first cross-sectional channel area. A planar cover member is next applied to the uncovered surface overlying the coated, open flow channel thereby to close the top of the flow channel and form the nanometer-scale conduit.

The nanostructured material transport devices produced by the above-described methods are also within the scope of this invention.

The present invention also provides a method of analyzing a target molecule, using a nanostructured device as described herein. In carrying out this analysis method, a potential difference is applied between spaced apart locations in the nano-opening of the nanostructured device, thereby causing an electric current between said locations and producing an electrical force which is effective to cause a target molecule which is exposed thereto to pass into the nano-opening. The target molecule has either an attractive or repelling interaction with the molecular coating thereby either decreasing or increasing the energy state of the molecule. Next, a target molecule is exposed to the electrical force produced in the preceding step and the electrical current is measured both before and after the target molecule passes into the nano-opening. The relative magnitude and temporal changes of the current measurements are indicative of at least one of the physical or chemical properties of the target molecule.

According to yet another aspect of this invention, there is provided a method of making a device for analysis of a target molecule. This method comprises: providing a solid substrate having a nano-opening defined by at least one wall surface fabricated in the substrate; applying to the wall surface a coating material having at least one property which is effective to promote self-assembly of molecular structures brought into engagement with the coating material; and engaging a molecular structure capable of self-assembly with the coated surface of the nano-opening. The molecular structure capable of self assembly might be brought to the coated nano-opening by either diffusive, convective, or electrokinetic forces.

As will be evident from the following detailed description, this invention provides structures fabricated with current know-how at larger lateral dimensions which can be reduced to the desired dimensions in a controlled fashion. Nanostructured devices having nano-openings with lateral dimensions confined to approximately 1 nm can be formed in accordance with this invention.

### BRIEF DESCRIPTION OF THE DRAWINGS

The novel aspects and advantages of the present invention will be apparent to those skilled in the art from the following detailed description thereof, considered in conjunction with the accompanying drawings, in which:

FIG. 1 is an enlarged, fragmentary plan view of a substrate on which is formed a channel structure including a nanochannel connecting microchannels, in which the channel surfaces are coated with a thin film/molecular coating, in accordance with the present invention.

FIG. 2 is an enlarged, fragmentary end view of a nanochannel with molecular coating. The open space shows the lateral extent of the flow area of reduced cross-sectional dimensions, resulting from application of the coating material, which is represented by the cross-hatching. The substrate surrounds the nanochannel on three sides; and a cover plate is superposed thereon.

FIG. 3 is an enlarged fragmentary end view of an open nanochannel with a molecular coating. The molecular coating is applied to the entire surface of the substrate containing the nanochannel. Effectively, only the width of the channel is reduced by the coating in this case.

FIGS. 4A and B show an enlarged fragmentary end view of an open nanochannel with a molecular coating. The substrate is patterned with a resist in FIG. 4A. The resist prevents the molecular coating material from interacting with the upper surface of the substrate, thus reducing both the effective channel depth and width after the resist has been selectively removed, as shown in FIG. 4B.

FIGS. 5A-C show a fragmentary, cross-sectional view of a nano-opening in the form of an orifice (FIG. 5A) with molecular coating applied to the wall surface thereof (FIG. 5B), thus reducing its diameter. A hydrophobic coating material may be used to make the wall surface receptive to insertion or engagement of a transmembrane protein containing a hydrophobic neck (FIG. 5C).

Like reference numbers designate like parts in those drawing figures in which they appear.

### DETAILED DESCRIPTION OF THE INVENTION

In carrying out this invention, coatings are applied to the walls of a nano-opening in a nanostructured device using either covalently or noncovalently attached species, including atoms or molecules, to further reduce its cross-sectional dimensions. Moreover, by appropriate selection of the coating material, liquid-solid interface characteristics of the coated nanochannel may be modified or controlled, as desired.

The expression “nano-opening” is used herein to refer to an orifice, passageway or conduit (the latter being a closed channel or an open channel) that has at least one nanoscale (<1000 nm) dimension.

The nanostructured material transport devices of the present invention can be made out of a variety of substrate materials, including but not limited to glass, fused silica, silicon, sapphire, gallium arsenide, and various polymeric materials, such as poly dimethylsiloxane) (PDMS), polycarbonate, polyolefins, and polymethylmethacrylate (PMMA) or combinations of such materials.

Nano-openings may be formed in a substrate surface by methods such as electron-beam lithography wet or dry chemical etching or by ion beam milling. These techniques are well-known to those skilled in the art.

Short nano-openings, or nanopores have been formed by ion beam milling through supported thin films of silicon nitride to form approximately 5-nm diameter holes (Li, et al., supra). The present invention has application to these types of nano-openings or nanopores, as well. The invention has applicability to any nanoscale passageway, independent of how it was formed, whenever it is desired to reduce the lateral dimension thereof. Fabrication of a nanoscale orifice in this way provides a potential solution to the above-noted problem of fragility of α-hemolysin nanopores and the lipid bilayers into which they are inserted. As an example, Li et al., supra, used a focused ion beam to create ˜5 nm pores, and demonstrated DNA transport through the pore. A nanopore fabricated by this technique could be reduced further in size by the method of this invention. Electroless deposition of gold to the interior surfaces of the nanochannel is one way of reducing the cross-sectional area from 100 nm² to 10 nm². See, for example, Jirage, et al., Effect of Thiol Chemisorption on the Transport Properties of Gold Nanotubule Membranes. Anal. Chem.,. 71(21): p. 4913-4918 (1999). This method is based on the use of a chemical reducing agent, typically tin, to plate a metal from solution onto a surface. Coating of the nanochannel is effected by filling the channel with a gold solution and chemically initiating the deposition. Although the gold layer is conductive and the specific resistivity is 10⁸ smaller than biological buffers, electrokinetic transport should still be feasible given the small cross sectional area. Different catalysts/reducing agents may be required depending on the composition of the nanochannel wall surface.

Alternatively, the cross-section of the nanochannel may be reduced by building up polymeric films on the inner surface. This approach allows the inner channel wall to have various, predetermined chemical properties, e.g. hydrophilic and hydrophobic characteristics.

According to a preferred embodiment, a polyelectrolyte may be applied in multi-layers as previously described by Dubas and Schlenoff, Macromolecules, 32: 8153-60 (1999). In this process, cationic and anionic polyelectrolytes are alternately exposed to the nanochannel surfaces. The oppositely charged materials form layers by charge compensation where the layers are of uniform thickness.

The coating material may be electrokineticaly driven through the nanochannel, in the manner described in the above-mentioned U.S. Pat. Nos. 5,858,195 and 6,001,229. This technique should be effective, provided that the electrophoretic mobility of the polyelectrolyte coating material exceeds the magnitude of the electrosmotic flow under the conditions employed. An advantage of this approach is that electrosmotic flow is reduced at appropriate nanoscale dimensions of the channels being coated, as compared to microscale channels. Electroosmotic flow is also reduced at increasing ionic strengths providing another mechanism for controlling its magnitude.

Coating reagents can also be transported through the channels to be coated by using hydraulic means. For example pressure can be applied to a reagent reservoir, attached directly or indirectly to a nanochannel, using a syringe pump or by applying a vacuum to the terminus of the nanochannel.

Using this method, coatings are formed in which the thickness is controlled to within the thickness of a single layer, and the overall thickness is dependent on the number of layers. A single polyelectrolyte layer has a thickness ranging from approximately 1 nm to a few tens of nanometers and multi-layer film thicknesses of approximately 1 micron have been formed.

Another polymeric material that may be used for coating siliceous nanochannel surfaces is linear polyacrylamide, which can be applied in the manner described by Hjerten, J. Chromatog., 347: 191-98 (1985). The thickness of such polymer coatings is controlled by the extent of the polymerization reaction. Living free radical polymerization is another polymer growth procedure that could be used to grow molecular coatings for the purpose described herein.

A further example of chemical treatment of the nanochannel wall surface, which simultaneously effects surface modification and reduction of the cross-sectional channel area of the flow channel, is chemical conversion of the substrate material. For example, if a silicon surface of a given thickness (X nm) is consumed by oxidation, then the resulting SiO₂ surface film will have a thickness of 1.56 X nm. In other words, a surface expansion of about 50% will be obtained. In the case of a 10-nm deep by 10 nm wide silicon channel, for example, growth of a 5 nm oxide coating on the channel wall surfaces thereof results in a channel depth of about 7.5 nm and a width of 5 nm.

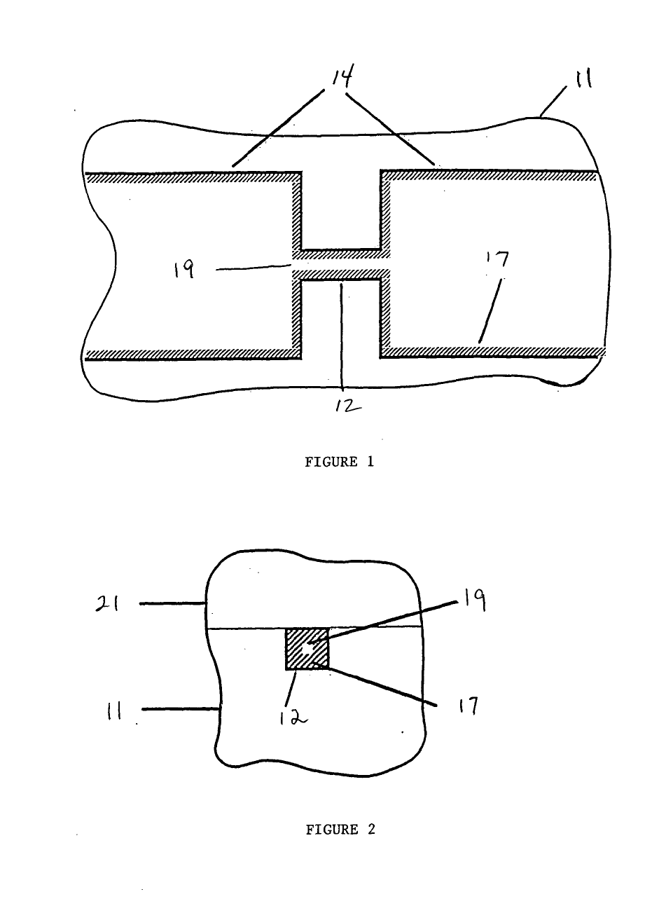

An embodiment of the present invention is schematically illustrated in FIGS. 1 and 2. FIG. 1 shows a substrate 11 with a single nanochannel 12 connecting two larger microchannels 14. Typically, the microchannels are a few orders of magnitude larger in lateral extent than the nanochannel. The depth of the nanochannel is, in general, similar to its lateral extent. The depth of the microchannels (a few microns), in general, will be less than the width but could be of nanometer scale. The lateral dimensions of the nanochannel can be further reduced by coating the entire channel assembly with an appropriate coating material 17, as indicated in FIG. 1 by the cross-hatching. This coating will result in minimal reduction of the microchannel cross-section while substantially reducing the nanochannel cross-sectional area 19.

FIG. 2 schematically shows an end view of a nanochannel 12 in a nanostructured material transport device that has been closed by affixing a cover plate 21 to the surface of substrate 11 and coating the walls of the nanoconduit thus formed.

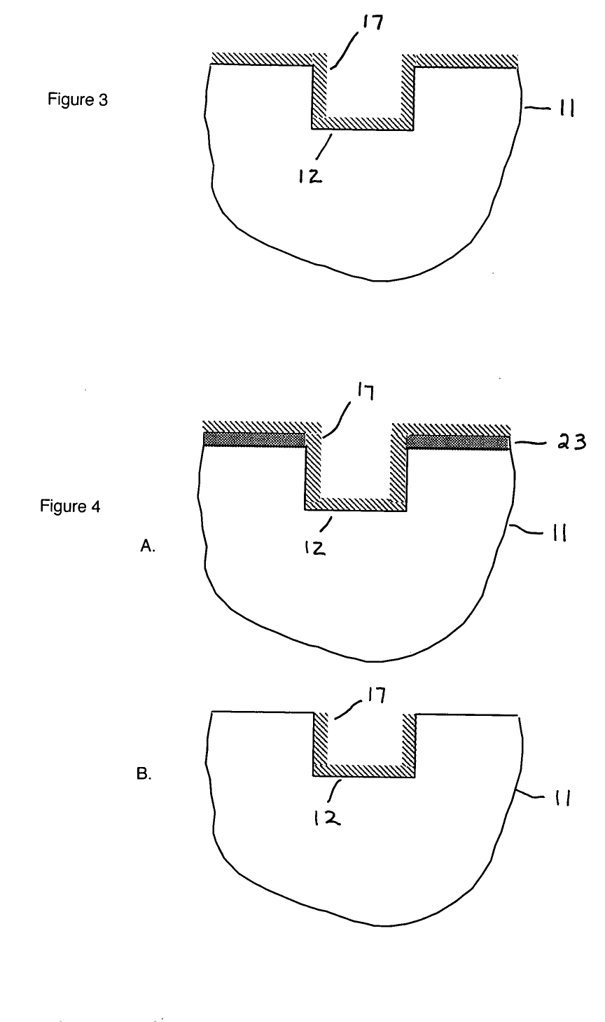

The coating material may be applied in such a way that the uncovered, upper surface of the substrate 11 is either coated or uncoated. In the former case, only the effective width of nanochannel 12 is reduced by the applied coating material 17, as illustrated in FIG. 3. In the embodiment shown in FIG. 4A, by contrast, a resist layer 23 is disposed on the uncovered, upper surface of substrate 11 prior to the coating operation. After the coating operation is completed, the resist layer 23 is selectively removed, along with the coating material 17 in contact therewith, thus reducing both the effective width and depth of nanochannel 12, as can be seen in FIG. 4B.

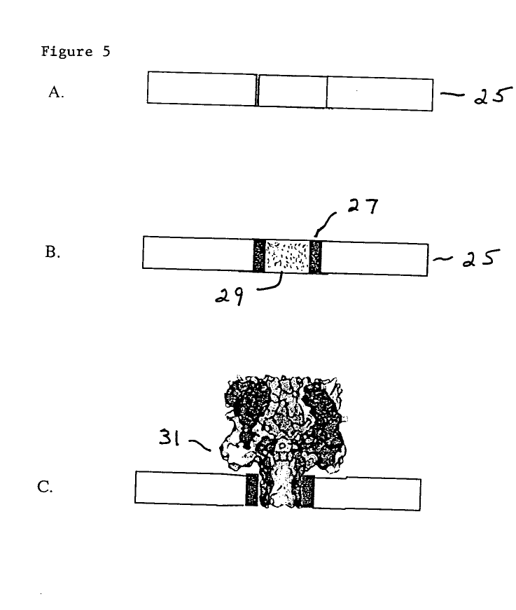

FIG. 5A is a schematic illustration in cross-section of a nano-orifice in a planar thin film 25 held on a supporting structure (not shown). FIG. 5B shows a reduction of the lateral dimensions of the nano-orifice as a result of applying a molecular film coating 27 as described above. The film coating can be grown to any predetermined thickness so that the desired orifice size is obtained. The resultant nano-orifice 29 could then be used directly in single molecule translocation experiments, thus eliminating the protein nanopore and the lipid bilayer. The engagement of a transmembrane protein 31, such as α-hemolysin, with the coated surface of the nano-opening (or disengagement, if desired) can be controlled under the influence of electrical forces. See, for example, the above-referenced U.S. Pat. Nos. 5,858,195 and 6,001,229.

In carrying out the translocation experiments, an electric potential would be applied across the orifice and the current measured. As a molecule enters the orifice, the current is, in general, reduced. Information about the properties, i.e. physical and/or chemical, of the molecule that has entered the orifice can be gleaned from the magnitude and temporal characteristics of the current signal.

The coating material can be appropriately selected to enable self-assembly of molecular structures disposed in a nano-opening prepared in accordance with this invention. For example, the applied film coating could be made hydrophobic in nature so that hydrophobic molecular assemblies such as the α-hemolysin protein complex could be inserted into the nano-orifice of FIG. 5B. Such a molecular “docking event” is schematically shown in FIG. 5C. The molecular coating in this case allows the mating or engagement of certain types of biological molecules to nanostructured solid-state materials. Such an assembly eliminates the fragile lipid bilayer materials used in the previously reported α-hemolysin demonstrations referenced hereinabove, and also insures that only one nanopore is present in an experiment. Molecular coatings that could be used for this purpose include, but are not limited to, hydrophobic polyelectrolyte multilayers and hydrophobic linear polymers, such as poly-dialkylacrylimides.

Insertion and self-assembly of molecular structures such as α-hemolysin in nano-openings can be carried out under the influence of electrical forces by first electrically biasing the nano-opening by connecting a voltage source to the buffer reservoirs adjoining the two sides of the nano-opening. Electrical connection to the solution in the reservoirs is made by inserting conducting electrodes, such as platinum electrodes, into the solution and connecting the poles of a voltage source to the electrodes. Details of the fabrication and operation of a material transport device of this design are provided in the aforementioned U.S. Pat. Nos. 5,858,195 and 6,001,229. In the case of a molecular assembly that has an isoelectric point such as proteins and polypeptides, the pH of the solution would be adjusted so that the molecular assembly is charged. The buffer solution containing the molecular assemblies can be brought into contact with the nano-opening by placing over the substrate containing the nano-opening using a dropper or pipette. Alternatively, microchannels could be interfaced with the substrate to transport the solution containing the molecular assemblies to the nano-opening. Once the molecular assemblies are in general proximity to the nano-openings, they can be brought to the nano-opening for interaction with the coating material by electrokinetic means through application of a voltage source across the nano-opening as described above. Prevention of insertion and self-assembly of such molecular structures may be similarly controlled by reversing the direction of the electrical forces.

The nano-orifice device shown in FIG. 5C could be used for single molecule sequencing/characterization measurements or it could be used as a chemical sensor, in a manner analogous to that described in Braha, et al., Chem. Biol., 4: 497-505 (1997); Gu, et al., Nature, 398: 686-690 (1999); Bayley and Cremer, Nature, 413: 226-230 (2001). Again, for this application the improved robustness provided by the mating of the sensing agent to a hard substrate will provide substantial benefit. It is also possible to tailor the molecular coating itself to be sensitive to particular compounds, e.g. as described in Steinle, et al., Analytical Chemistry, 74: 2416-2422 (2002). If desired, the coating material can be modified to include a sensing agent which specifically binds a target substance of interest. The target substance of interest will typically be an analyte of biological significance, but may include other analytes such as priority pollutants, insecticides or the like. Representative examples of biological analytes that may be specifically bound by a sensing agent include cell-associated structures, such as membrane-bound proteins or glycoproteins, e.g. cell surface antigens of either host or viral origin, histocompatability antigens or membrane receptors, as well as biomolecules, preferably biopolymers such as nucleic acids and proteins. The target substance of interest may be present in biological specimens of varying origin, environmental test samples or the like.

As mentioned above, the sensing agent is capable of specifically binding the target substance of interest, which means that it selectively participates in a binding interaction with a target substance of interest to the substantial exclusion of other substances that are not of interest. Materials having this capability which can function as sensing agents are those commonly used in affinity-binding separations, namely, antibodies, anti-haptens, anti-lectins, peptides, peptide-nucleic acid conjugates, nucleic acids, protein A, protein G, concanavalin A, soybean agglutinin, hormones and growth factors. The term “antibody”, as such herein, is intended to include monoclonal or polyclonal immunoglobulins, immunoreactive immunoglobulin fragments, as well as single chain antibodies. Representative examples of target substances and sensing agents which specifically bind them are: antigen-antibody; hormone-receptor; ligand-receptor; agonist-antagonist, RNA or DNA molecules-complimentary sequences, avidin-biotin and virus-receptor. These target substance-sensing agent combinations may be referred to as specific binding pairs.

Various chelators which bind to distinct metallic species may also be used as sensing agents, if desired.

In this embodiment of the invention also, chemical sensing information is derivable from the temporal and/or magnitude of the current variations measured through the biased orifice.

All patent and literature citations mentioned in this specification are incorporated by reference herein in their entirety.

While certain embodiments of the present invention have been described above, various other embodiments will be apparent to those skilled in the art from the foregoing disclosure. The present invention is, therefore, not limited to the particular embodiments described, but is capable of considerable variation and modification without departing from the scope of the appended claims.

1. A method of reducing a cross-sectional dimension of a nano-opening in a nanostructured device, comprising the steps of:
a. providing a solid substrate including a nano-opening defined by at least one wall surface fabricated in said substrate, said nano-opening having a given first cross-sectional area of nanometer-scale dimensions bounded by said at least one wall surface; and
b. applying a coating material having a defined thickness to said at least one wall surface, thereby causing said nano-opening to have a second cross-sectional area of nanometer-scale dimensions reduced relative to said first cross-sectional area.

2. The method of claim 1 wherein said at least one wall surface comprises three wall surfaces defining a substantially rectangular, open nanochannel having a first width and a first depth, said second cross sectional area having a second width reduced by approximately twice said defined thickness.

3. The method of claim 2, including the step of enclosing said nanochannel with an uncoated cover member after applying said coating material, said channel having a second depth reduced by approximately said defined thickness.

4. The method of claim 2 including the step of enclosing said nanochannel prior to applying said coating material to provide a fourth wall surface, said nanochannel having a second depth reduced by approximately twice said defined thickness.

5. The method of claim 1 wherein said at least one wall surface is a continuous wall defining a hollow cylinder, and said second cross-sectional area has a diameter reduced by approximately twice the coating thickness.

6. A method according to claim 1, wherein said step of applying a coating material having a defined thickness is effected by ion implantation.

7. A method according to claim 1, wherein said step of applying a coating material having a defined thickness is effected by film deposition.

8. A method according to claim 1, wherein said step of applying a coating material having a defined thickness coats said at least one wall surface with a metal.

9. A method according to claim 1, wherein said step of applying a coating material having a defined thickness coats said at least one wall surface with an ionic material.

10. A method according to claim 1, wherein said step of applying a coating material having a defined thickness coats said at least one wall surface with a molecular film.

11. A method according to claim 10 where the molecular film is covalently attached the solid substrate.

12. A method according to claim 10 where the molecular film is non-covalently attached the solid substrate.

13. A method according to claim 1, wherein said step of applying a coating material having a defined thickness coats said at least one wall surface by chemical conversion of the solid substrate material.

14. A method according to claim 13, wherein said solid substrate materials is silicon and said chemical conversion is the formation of silicon oxide.

15. A method according to claim 1, wherein said step of applying a coating material having a defined thickness coats said at least one wall surface with a polymeric material.

16. A method according to claim 1, wherein said step of applying a coating material having a defined thickness coats said at least one wall surface with at least one polyelectrolyte material.

17. A method according to claim 16, further including the step of applying to said at least one wall surface a polyelectrolyte material providing at least one additional coating of defined thickness, the charge of the polyelectrolyte which provides said at least one additional coating being opposite to the charge of the polyelectrolyte to which it is applied.

18. A method according to claim 1, where the step of applying a coating material having a defined thickness coats said at least one wall surface and modifies the solid-liquid interaction characteristic.

19. A method according to claim 2, wherein said step of providing a solid substrate with an open nanochannel includes the step of providing a substrate having both said open nanochannel and a microchannel having a free space with a third cross-sectional area greater than said first cross-sectional channel area, said microchannel being connected to said nanochannel, said coating step also including coating said microchannel with a coating of said defined thickness to reduce the free space of said microchannel, said thickness being sufficiently small to maintain the cross-sectional area of said microchannel free space larger than the cross-section area of said nanochannel free space.

20. A method according to claim 3, wherein the step of applying a coating material to the open nanochannel is carried out while maintaining the adjacent substrate surface substantially free of said coating material.

21. A method according to claim 20, wherein said adjacent substrate surface is maintained substantially free of said coating material, by applying a resist layer to said adjacent substrate surface prior to application of said coating material, and removing said resist layer after application of said coating material.

22. A method of producing a nanometer-scale conduit in a nanostructured device, comprising the steps of:
providing a solid substrate having an uncovered surface;
forming in said surface an open nanochannel having a bottom wall spaced below said uncovered surface and opposed side walls, said nanochannel having a given first cross-sectional channel area of nanometer-scale dimensions defined by the free space between said opposed sidewalls and the depth of said bottom wall below said uncovered surface;
applying a coating material having a defined thickness to said opposed side walls and said bottom wall to reduce the free space between said coated opposed side walls by a factor of two times the defined thickness, and thereby to reduce the free space in said first cross sectional area to provide a flow channel having a flow area with a second cross-sectional area of lesser nanometer-scale dimensions relative to said first cross-sectional channel area; and
applying a planar cover member to said uncovered surface overlying said coated, open flow channel to thereby close the top of said flow channel and form said nanometer-scale conduit.

23. A method according to claim 22, wherein said open nanochannel is formed by chemical etching.

24. A method according to claim 22, wherein said open nanochannel is formed by milling said surface with a finely-focused ion beam to form said open nanochannel.

25. A nanostructured device for use in transporting a fluid medium having components of differing maximum lateral dimension, said device having a nanometer-scale conduit and comprising a solid substrate having an upper surface, a nanochannel having a bottom wall spaced below said upper surface and opposed side walls, said nanochannel having a given first cross-sectional channel area of nanometer scale dimensions defined by the free space between said opposed sidewalls and the depth of said bottom wall below said upper surface, a coating material having a defined thickness covering said opposed side walls and said bottom wall, said coating material reducing the free space between said opposed side walls by a factor of approximately two times the defined thickness, and thereby providing a cross-sectional flow area in said nanochannel of reduced nanoscale dimensions relative to said first cross-sectional channel area, and a planar cover member on said upper surface overlying said coated nanochannel, which closes the top of said channel and forms said nanometer-scale conduit.

26. A nanostructured device according to claim 25, wherein said substrate includes a microchannel having lateral dimensions greater than the differing maximum lateral dimensions of the fluid medium components to accommodate flow of said fluid medium therethrough, said microchannel communicating with said coated, nanometer-scale conduit, whereby flow from said microchannel into said nanometer-scale conduit is restricted to components of said fluid medium having a maximum lateral dimension smaller than said lateral dimensions of said coated nanometer-scale conduit.

27. A nanostructured device according claim 26 wherein the rate of transport of said fluid medium components through said nanoscale conduit is dependent on the lateral dimensions of the fluid medium components relative to the lateral dimensions of the nanoscale conduit.

28. A nanostructured device according to claim 25, wherein said fluid medium components include molecules of differing dimensions, said microchannel has a cross-sectional area larger than the molecules in said fluid medium, and the free space dimensions of said nanometer-scale conduit is larger than the dimension of at least one of said molecules and is smaller than the dimension of at least one other of said molecules.

29. A nanostructured device according to claim 25, wherein said coating comprises a metal film.

30. A nanostructured device according to claim 25, wherein said coating comprises an ionic material.

31. A nanostructured device according to claim 25, wherein said coating comprises a molecular film.

32. A nanostructured device according to claim 25, wherein said coating comprises polymeric material.

33. A nanostructured device according to claim 25, wherein said coating comprises at least one polyelectrolyte material.

34. A nanostructured device according to claim 33, wherein said coating comprises a plurality of layers of polyelectrolyte material, each layer being opposite in charge to its adjacent layer.

35. A nanostructured device according to claim 25, wherein the lateral dimension of said nanometer-scale conduit is approximately one nanometer.

36. A nanostructured device comprising a solid substrate having a nano-opening of predetermined cross-sectional area defined by at least one wall surface which is fabricated in said substrate and which is coated with a coating material so as to reduce said predetermined cross-sectional area.

37. The nanostructured device of claim 36, wherein said at least one wall surface is a continuous wall defining a hollow cylinder.

38. The nanostructured device of claim 36, wherein said coating material is modified to include a sensing agent which specifically binds a target substance of interest.

39. The nanostructured device of claim 36, wherein said coating material is hydrophobic and is associated with a molecular assembly.

40. The nanostructured device of claim 39 wherein said molecular assembly is a transmembrane protein.

41. The nanostructured device of claim 40, wherein said transmembrane protein is an ion channel.

42. The nanostructured device of claim 41, wherein said ion channel is alpha-hemolysin.

43. The nanostructured device of claim 39, wherein said coating material is selected from the group consisting of hydrophobic polyelectrolyte multilayers and hydrophobic linear polymers and said transmembrane protein is alpha-hemolysin.

44. A method of analyzing a biomolecule, said method comprising:
a) providing a nanostructured device as claimed in claim 36;
b) applying a potential difference between spaced apart locations in the nano-opening of said nanostructured device, thereby causing an electric current between said locations and producing an electrical force which is effective to cause a biomolecule which is exposed to said electrical force to pass into said nano-opening;
c) exposing a biomolecule to the electrical force produced in step b;
d) measuring said electrical current before said biomolecule passes into said nano-opening; and
e) measuring said electric current after said biomolecule passes into said nano-opening, the relative magnitude and temporal changes of said current measurements being indicative of at least one of the physical or chemical properties of said biomolecule.

45. The method of claim 44, wherein said biomolecule is a linear biopolymer.

46. The method of claim 44, wherein said nano-structure device is provided with a hydrophobic coating material, and includes a further step of engaging a transmembrane protein with said hydrophobic coating material before exposing said biomolecule to said electrical force.

47. The method of claim 44, wherein said coating material is modified to include a sensing agent which specifically binds said biomolecule.

48. A nanostructured device comprising a solid substrate having a nano-opening defined by at least one wall surface fabricated in said substrate, said nano-opening being coated with a coating material having at least one property which is effective to promote self-assembly of a molecular structure brought into engagement with said coating material.

49. The nanostructured device of claim 48, wherein said at least one wall surface is a continuous wall defining a hollow cylinder.

50. The nanostructured device of claim 48, wherein said coating material is hydrophobic and said molecular structure is a transmembrane protein.

51. The nanostructured device of claim 50, wherein said transmembrane protein is an ion channel.

52. The nanostructured device of claim 50, wherein said coating material is selected from the group consisting of hydrophobic polyelectrolyte multilayers and hydrophobic linear polymers, and said transmembrane protein is alpha-hemolysin.

53. A method of making a device for analysis of a biomolecule, said method comprising:
a) providing a solid substrate having a nano-opening defined by at least one wall surface fabricated in said substrate;
b) applying to said wall surface a coating material having at least one property which is effective to promote self-assembly of molecular structures brought into engagement with said coating material; and
c) engaging a molecular structure capable of self-assembly with said coating material.

54. The method of claim 53, wherein said molecular structure capable of self-assembly is brought into engagement with said coating material under the influence of an electrical force.

55. The method of claim 53, including the further step of disengaging said molecular structure from said coating material by reversing the direction of said electrical force.

56. The method of claim 53, including the further step of preventing engagement of said molecular structure with said coating material by reversing the direction of said electrical force.
